(19) United States
(12) Patent Application Publication
(10) Pub. No.: US 2011/0123967 A1
(43) Pub. Date: May 26, 2011

(54) DIALOG SYSTEM FOR COMPREHENSION EVALUATION

(75) Inventors: Florent C. PERRONNIN, Domene (FR); Caroline Brun, Grenoble (FR); Kristine A. German, Webster, NY (US); Robert M. Lofthus, Webster, NY (US)

(73) Assignee: Xerox Corporation, Norwalk, CT (US)

(21) Appl. No.: 12/624,960

(22) Filed: Nov. 24, 2009

(51) Int. Cl. G09B 17/00; G09B 7/00

(52) U.S. Cl. 434/178; 434/327; 434/362

(57) ABSTRACT

An automated system, apparatus and method for evaluation of comprehension are disclosed. The method includes receiving an input text and natural language processing the text to identify dependencies between text elements in the input text. Grammar rules are applied to generate questions and associated answers from the processed text, at least some of the questions being based on the identified dependencies. A set of the generated questions is posed to a reader of the input text and the comprehension of the reader evaluated, based on the reader's responses to the questions posed.

### BACKGROUND

The exemplary embodiment relates to the development of reading skills. It finds particular application in connection with a dialog system and an automated method for comprehension assessment based on an input text document, such as a book.

The ultimate goal of reading is comprehension. This is the reason why, when teachers assess the reading level of children, they do not only rate their reading fluency but also their understanding. For example, three broad criteria are used by teachers to assess the reading ability of children: reading engagement, oral reading fluency, and comprehension, the last one typically accounting for 50% of the final grade. However, the evaluation of the reading ability of a child by a teacher is a lengthy process which often happens infrequently. Deficiency in reading skills, especially, reading comprehension, is considered an important factor in students failing to graduate from high school.

Automated systems, typically based on speech recognition technology, have been developed to evaluate and improve a child's reading fluency without the intervention of an adult. Comprehension, however, is a more difficult reading skill to assess by automated techniques, particularly for young readers.

### INCORPORATION BY REFERENCE

The following references, the disclosures of which are incorporated herein by reference in their entireties, are mentioned:

U.S. Pub. No. 2009/0246744, published Oct. 1, 2009, entitled METHOD OF READING INSTRUCTION, by Robert M. Lofthus, et al., discloses a method of automatically generating personalized text for teaching a student to learn to read. Based upon inputs of the students reading ability/level, either from a self assessment or teacher input, and input of personal data, the system automatically searches selected libraries and chooses appropriate text and modifies the text for vocabulary and topics of character identification of personal interest to the student. The system generates a local repository of generated text associated with a particular student.

The following references relate generally to methods of assessing reading fluency: U.S. Pat. No. 6,299,452, entitled DIAGNOSTIC SYSTEM AND METHOD FOR PHONOLOGICAL AWARENESS, PHONOLOGICAL PROCESSING, AND READING SKILL TESTING; U.S. Pat. No. 6,755,657, entitled READING AND SPELLING SKILL DIAGNOSIS AND TRAINING SYSTEM AND METHOD; U.S. Pub. No. 2007/0218432 entitled SYSTEM AND METHOD FOR CONTROLLING THE PRESENTATION OF MATERIAL AND OPERATION OF EXTERNAL DEVICES; and U.S. Pub. No. 2004/0049391, entitled SYSTEMS AND METHODS FOR DYNAMIC READING FLUENCY PROFICIENCY ASSESSMENT.

The following references relate generally to automatic evaluation and assisted teaching methods: WO 2006121542, entitled SYSTEMS AND METHODS FOR SEMANTIC KNOWLEDGE ASSESSMENT, INSTRUCTION AND ACQUISITION; U.S. Pub. No. 2004/0023191, entitled ADAPTIVE INSTRUCTIONAL PROCESS AND SYSTEM TO FACILITATE ORAL AND WRITTEN LANGUAGE COMPREHENSION, by Carolyn J. Brown, et al.; and U.S. Pat. Nos. 6,523,007 and 7,152,034, entitled TEACHING METHOD AND SYSTEM, by Terrence V. Layng, et al.

The following references relate to natural language processing of text: U.S. Pat. No. 7,058,567, issued Jun. 6, 2006, entitled NATURAL LANGUAGE PARSER, by Salah Aït-Mokhtar, et al., U.S. Pub. No. 2009/0204596, published Aug. 13, 2009, entitled SEMANTIC COMPATIBILITY CHECKING FOR AUTOMATIC CORRECTION AND DISCOVERY OF NAMED ENTITIES, by Caroline Brun, et al., U.S. Pub. No. 2005/0138556, entitled CREATION OF NORMALIZED SUMMARIES USING COMMON DOMAIN MODELS FOR INPUT TEXT ANALYSIS AND OUTPUT TEXT GENERATION, by Caroline Brun, et al., U.S. Pub. No. 2002/0116169, published Aug. 22, 2002, entitled METHOD AND APPARATUS FOR GENERATING NORMALIZED REPRESENTATIONS OF STRINGS, by Salah Aït-Mokhtar, et al., and U.S. Pub. No. 2007/0179776, published Aug. 2, 2007, entitled LINGUISTIC USER INTERFACE, by Frédërique Segond, et al.

### BRIEF DESCRIPTION

In accordance with one aspect of the exemplary embodiment, a method for evaluation of a reader's comprehension, includes receiving an input text, natural language processing the text to identify dependencies between text elements in the input text, applying grammar rules to generate questions and associated answers from the processed text, at least some of the questions each being based on at least one of the identified dependencies, and automatically posing questions from the generated questions to a reader of the input text. Reading comprehension of the reader is evaluated based on received responses of the reader to the questions posed.

In accordance with another aspect of the exemplary embodiment, a system for evaluation of a reader's comprehension includes memory which stores instructions for receiving natural language processed input text, for applying grammar rules to generate questions and associated answers from the processed text. At least some of the questions are based on syntactic dependencies identified in the processed text. Instructions for posing questions from the generated questions to a reader of the input text and evaluating comprehension of the reader based on received responses of the reader to the questions posed are also stored. A processor in communication with the memory executes the instructions.

### BRIEF DESCRIPTION OF THE DRAWINGS

FIG. 1 is a functional block diagram of an apparatus for evaluating reading comprehension;

FIG. 2 illustrates software components of the apparatus of FIG. 1;

FIG. 3 illustrates components of the dialog system of FIG. 1;

FIG. 4 is a flow diagram illustrating an evaluation method;

FIG. 5 illustrates a question generated through natural language processing; and

FIG. 6 illustrates another question generated through natural language processing.

### DETAILED DESCRIPTION

Aspects of the exemplary embodiment relate to a dialog system for evaluating the comprehension of a text document in a natural language, such as a book, magazine article, paragraph, or the like, by a reader, such as a child learning to read or an adult learning a second language. The exemplary dialog system asks questions to the reader, assesses the correctness of the answers and provides help in the case of incorrect answers.

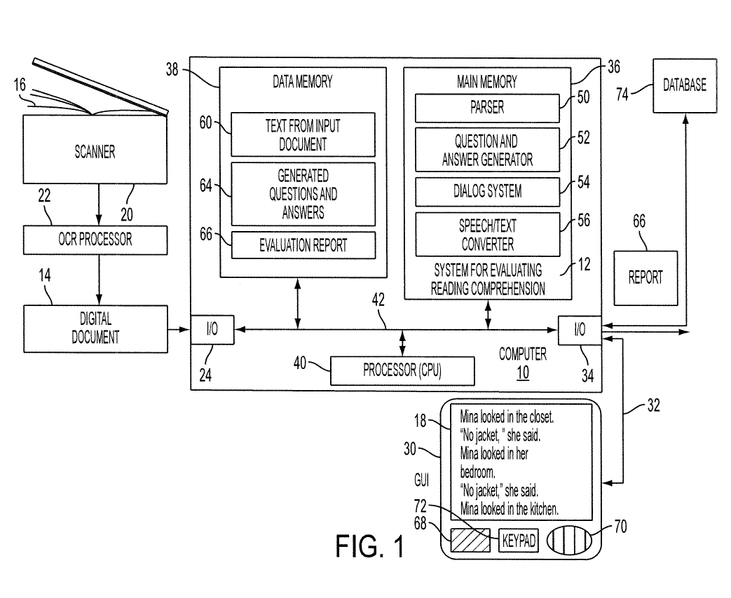

With reference to FIG. 1, an apparatus 10, which hosts a system 12 for evaluating reading comprehension, is shown. The apparatus 10 takes as input a children's book 14. Such a book typically contains text and images and the proportion of text with respect to images increases with the reading level. However, other text-containing documents 14, such as a magazine article, or personalized reading material with reader-appropriate text (see, for example, U.S. Pub. No. 2009/0246744) are also contemplated as inputs. In the exemplary embodiment, the book 14 is in an electronic format, e.g., the text is available in ASCII format and the accompanying images in an image format, such as JPEG. A child may be provided with a hard copy 16 of the book to read, which corresponds to the digital version 14. For older children, the digital version may be displayed and read on a display screen 18 integral with or communicatively linked to the apparatus 10.

In other embodiments, the hard copy book 16 may be scanned by a scanner 20 and optical character recognition (OCR) processed by an OCR processor 22 to generate a digital document 14 comprising the text content. In this embodiment, OCR processor 22 may be incorporated in the scanner 20, computing device 10, or linked thereto.

The digital document 14 is received by the apparatus 10 via an input device 24, which can be a wired or wireless network connection to a LAN or WAN, such as the Internet, or other data input port, such as a USB port or disc input.

Apparatus 10 may be a dedicated computing device, such as a PDA or e-reader which also incorporates the screen 18. In another embodiment, computer 10 may a general purpose computer or server which is linked to a user interface 30 by a communication link 32, such as a cable or a wired or wireless local area network or wide area network, such as the Internet. The GUI 30 may be linked to the computer 10 via an input/output device 34, such as a modem or communication port. In another embodiment, the apparatus 10 may be hosted by a printer which prints a hard copy of the book.

The computer 10 includes memory 36, 38 and a processor 40, such as the computer's CPU. Components 24, 34, 36, 38, of the computer 10 are linked by a data/control bus 42.

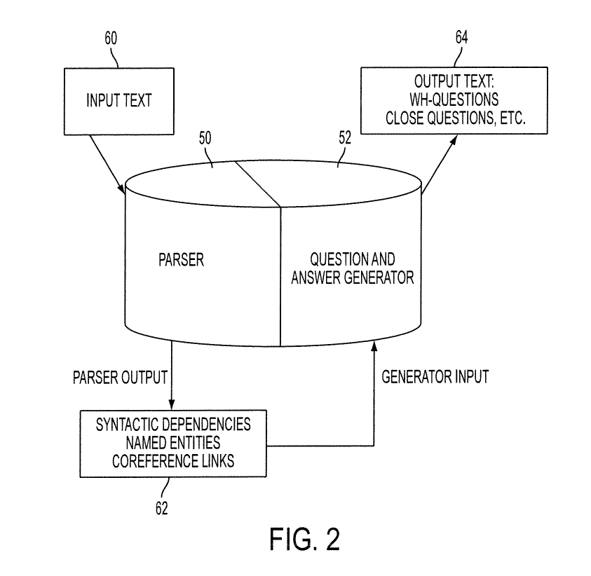

The evaluation system 12 hosted by computer 10 may be in the form of hardware, software or a combination thereof. The exemplary evaluation system 12 includes various software components 50, 52, 54, 56, stored in computer memory, such as computer 10's main memory 36, and which are executed by the processor 40. As illustrated in FIG. 2, these components may include a natural language parser 50, which processes input text 60 from document 14 and outputs processed text 62, e.g., tagged or otherwise labeled according to parts of speech, syntactic dependencies between words or phrases, named entities, and co-reference links, and described in greater detail below. The output text 62 is in a format which can be automatically processed by a question generator 52 into a set of questions 64 and corresponding answers. The question generator 52 may be in the form of a set of rules written on top of the parser grammar rules using the same computing language or may be a separate software component. The processed text 62 and generated questions and answers 64 may be temporarily stored in computer memory, such as data memory 38.

Returning to FIG. 1, the evaluation system 12 also includes a dialog system 54, which is configured for posing a set of the generated questions retrieved from memory 38 to a child, or other reader of the book. The dialog system 54 receives the reader's responses and evaluates the responses to generate an evaluation of the reader's comprehension, e.g., in the form of a report 66. In one embodiment, the dialog system 54 causes the questions to be displayed as text on the display 18. In another embodiment, the questions are posed orally. In this embodiment, the evaluation system 12 may incorporate a text to speech converter 56, which converts the text questions to synthesized speech. Speech converter 56 is linked to a speech output device 68, such as a speaker or headphones of the user interface 30.

The reader's responses may be provided orally and/or by text input. In the case of oral responses, these may be provided via a microphone 70, and the signals received from the microphone returned to the evaluation system 12 for processing. The processing may include speech to text conversion, in which case the stored text answer is compared with the reader's converted answer. Or, a comparison of the spoken response with a synthesized version of the stored answer may be made using entire word comparison or analysis of identified phonemes making up the stored answer and reader's response. Phonemes are generally defined as a set of symbols that correspond to a set of similar speech sounds, which are perceived to be a single distinctive sound. For example, the input speech can be converted by a decoder into phonemes in the International Phonetic Alphabet of the International Phonetic Association (IPA), the ARPAbet standard, or XSampa. Each of these systems comprises a finite set of phonemes from which the phonemes representative of the sounds are selected. For convenience, only a single converter 56 is shown although it is to be appreciated that separate components may be provided for text to speech and speech to text conversion, respectively.

For text responses, provision may be made for the reader to enter typed answers, e.g., via a text entry device 72, such as a keypad, keyboard, touch screen or the like, or to accept one of a set of possible answers displayed on the screen, e.g., by clicking on the answer with a cursor control device.

The apparatus 10 may be configured for outputting the report 66, e.g., as a text document, and/or storing the information for the particular child in a database 74, located either locally or remotely, from where the information can be retrieved the next time that child is to be evaluated, e.g., to provide a basis for question selection and/or to evaluate the child's progress.

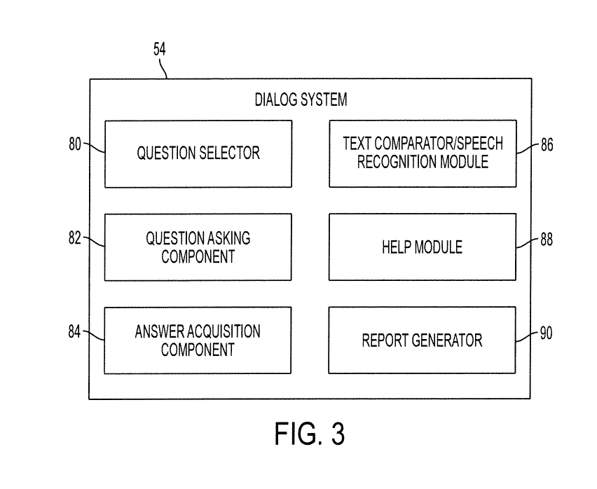

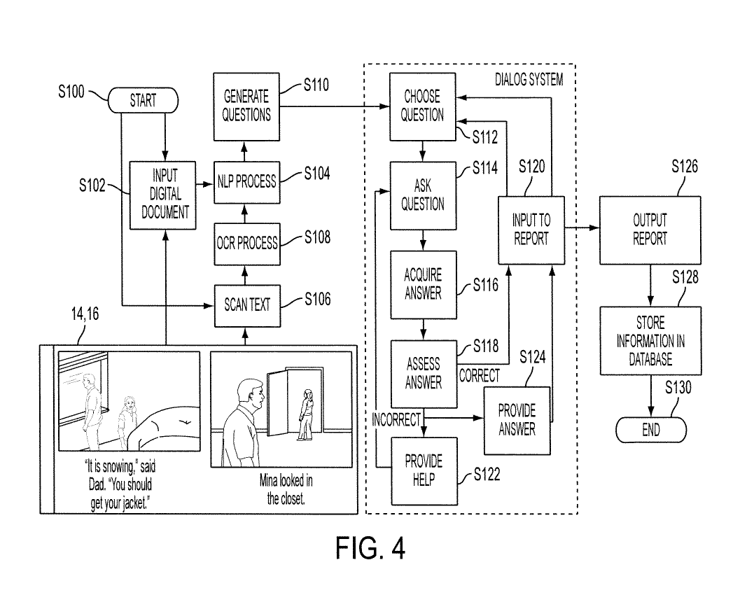

With reference also to FIG. 3, the dialog system 54 may include software instructions to be executed by the processor 40 for performing steps of the exemplary method shown in FIG. 4. For ease of reference, separate software components are shown in FIG. 3, including a question selector 80, a question asking component 82, an answer acquisition component 84, an answer checking component 86, which may include a text and/or speech comparator, a help module 88, which is actuated in the case of an incorrect or absent answer, and a report generator 90. However, it is to be appreciated that the dialog system components may be combined or additional or fewer components provided. Additionally, while in the exemplary embodiment the components are all resident on computer 10, it is to be appreciated that various ones of the components may be distributed among two or more computing devices, e.g., accessible on a server computer. The components are best understood with reference to the method and are not described in detail here.

The digital processor 40, in addition to controlling the operation of the computer 10, executes instructions stored in memory 36 for performing the method outlined in FIG. 4. The processor 40 can be variously embodied, such as by a single-core processor, a dual-core processor (or more generally by a multiple-core processor), a digital processor and cooperating math coprocessor, a digital controller, or the like.

The computer memories 36, 38 (or a single, combined memory) may represent any type of tangible computer readable medium such as random access memory (RAM), read only memory (ROM), magnetic disk or tape, optical disk, flash memory, or holographic memory. In one embodiment, the memory 36, 38 comprises a combination of random access memory and read only memory. In some embodiments, the processor 40 and main memory 36 may be combined in a single chip.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

FIG. 4 illustrates a method for evaluating comprehension which may be performed with the apparatus of FIGS. 1-3. The method begins at S100. At S102, a digital document 14, such as a book, is input and stored in memory 38. At S104, the text part of the digital document is subjected to natural language processing (NLP) by the parser 50 and the processed text 62 may be temporarily stored in memory 38, e.g., indexed by page number.

In another embodiment, a hardcopy document 16 is scanned at S106 and OCR processed at S108 prior to NLP at S104.

At S110, a list of questions (and corresponding answers) 64 is automatically generated from the NLP processed textual part 62 of the book by the question generator 52 and may be stored in memory 38. The answers may be stored as text. Additionally or alternatively, the answers may be stored synthesized spoken whole words/phonemes, in the case of an oral system, for direct comparison with the reader's answer. At S112, the dialog system 54 automatically selects a question from the generated set. The selection may be purely random or based at least in part on the chronology of the story. For example, the first question may be from the first page of the book. At S114, the question is posed to the reader, for example, by automatically converting the text to synthesized speech and outputting the sounds through the speaker 68 and/or by displaying the question as text on the display 18.

At S116, the reader's answer is acquired. For example, the reader is prompted to answer the question and if oral, it is received by the microphone 70 and may be converted to a format in which it can be compared with the stored answer. Alternatively the user may input a text answer which is received and may be stored in memory 38.

At S118, the correctness of the reader's answer is automatically assessed. For example, the answer is compared with the answer stored in memory (e.g., as text or as a word sound/phonemes). If the answer given is determined to be correct (i.e., matches the stored answer with a reasonable accuracy), then at S120, a record that the question was answered correctly is stored in memory for subsequently evaluating the comprehension of the reader, based on the reader's answers, and generating a report 66 based thereon. The method then returns to S112. If, however, the answer is determined to be incorrect at S118, the method may proceed to a help stage S122. Various methods for helping the child to answer correctly are contemplated. In one embodiment, the child may be provided with textual or visual clues. The method may thereafter return to S114, where the question is asked again or a modified question asked, and/or proceed to S124, where the correct answer is given. The information that the question was answered incorrectly, or correctly with help, is recorded at S120, and the method returns to S112. The dialog part of the process may be repeated through one or more loops before the evaluation of the reader's comprehension is performed and an evaluation report is generated and output at S126. At S128, statistics related to the child may be recorded in the database 74, e.g., to follow his/her progress over time. Statistics from the child's previous reading experiences and ‘comprehension evaluation sessions’ can also influence the current session, e.g., the style and/or order in which questions are asked.

The method ends at S130.

The method illustrated in FIG. 4 may be implemented in a tangible computer program product that may be executed on a computer by a computer processor. The computer program product may be a computer-readable recording medium on which a control program is recorded, such as a disk, hard drive, or the like. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use. Alternatively, the method may be implemented in a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 4, can be used to implement the evaluation method.

Various steps of the method are now discussed in more detail.

### 1) Automatic Generation of Questions (S110)

Automatic question generation is of considerable value in the context of educational assessment where questions are intended to evaluate the respondent's knowledge or understanding. The exemplary system 12 provides the ability to generate questions automatically (as opposed to using questions generated by an adult) for any book 14, 16 without apriori knowledge of its contents. The book 14, 16 may be selected by the child's teacher/evaluator or by the child, before the questions are generated, and the questions then generated automatically by inputting the book to the system 12. Thus, virtually any text can be selected which is in the natural language used by the system 12, e.g., English or French.

The question generation component 52 takes as input one or more NLP processed sentences 62 and gives as output, a set of questions related to the input text. The questions may be of various types, and may be generated, for example, by methods such as question topic detection (terms, entities), question type determination: cloze questions (fill-in-the-blank type questions), wh-questions (who, what, when, where, or why type questions), vocabulary (antonyms, synonyms), and question construction, generally via transformation rules over the selected natural language-processed source sentence(s) 62.

The system 12 can also generate multiple choice tests to assess vocabulary and/or grammar knowledge (see for example Mitkov, R. and Ha, L. A., Computer-Aided Generation of Multiple-Choice Tests, in Proc. HLT-NAACL 2003 Workshop on Building Educational Applications Using Natural Language Processing, Edmonton, Canada, May, pp. 17-22 (2003)). For example, the system 12 may identify important concepts in the text (term extraction) and generate questions about these concepts as well as multiple choice distractors (using Wordnet hypernyms, for example). The system may also ask comprehension questions by rephrasing the source sentences (see, e.g., John H. Wolfe, Automatic question generation from text—an aid to independent study, ACM SIGCUE Bulletin, 2(1), 104-112 (1976) for a description of the precursor to Autoquest). Finally, the system 12 may identify key concepts in source sentences to generate cloze deletion tests (see, for example, Coniam, D. A Preliminary Inquiry into Using Corpus Word Frequency Data in the Automatic Generation of English Cloze Tests, CALICO Journal, No. 2-4, pp. 15-33 (1997)).

In the exemplary embodiment, the parser 50 provides the question generation component 52 with information extracted from the input sentences or shorter or longer text strings (syntactic and sometimes semantic), as well as extracted named entities and coreference information, as described below.

### 2) Choosing and Asking a Question (S112, S114)

Multiple strategies can be considered for selecting questions from the generated list. One way is to simulate the process of retelling the story, i.e., to ask questions in an order which respects the narrative flow. Another approach is to start with generic questions (such as “who is the main character?”) and then to consider more specific questions.

Another approach is to target the questions in accordance with the learning goals. For instance, one goal of reading is to enrich the child's vocabulary. Official lists of words exist that children are expected to master in each grade (see, e.g., http://www.tampareads.com/trial/vocabulary/index-vocab.htm). Such lists may be used to guide the choice of questions. If the evaluation system 12 has prior information about the child's reading level (actual or expected reading level) or the book designated reading level, the dialog system 54 may ask questions related to words corresponding to that level. For example, when a book is input, metadata may be extracted which provides the reading level, or the information may be input manually by the evaluator in response to a prompt. If the dialog system 54 does not have this prior information, it may start with easy questions, i.e., questions pertaining to words corresponding to an early reading level and then, in the case of correct answers, move on to more complex questions, i.e., questions pertaining to words corresponding to a more advanced reading level.

Yet another way to choose a question is to target those parts of the book 14 with which the child seems to have most difficulties. For instance, if the child previously answered a question incorrectly, then the dialog system 54 may choose to ask a question on the same part (e.g., the same sentence).

Once the question has been selected, it may be presented to the child in various forms. For instance, it may be displayed on the screen. Or, speech synthesis technology 56 may be used by the dialog system 54 so that the question is uttered.

### 3) Acquiring and Assessing the Answer (S116, S118)

In the same manner, the answer may be provided by the child in different forms: e.g., it may be typed on the keyboard 72 or it may be uttered. In the case of young children, the expected answers may be fairly simple, e.g., a single name/word.

Where the child utters the answer into the microphone 70, which is linked to the system 12, one word answers generally make recognition of correct answers easier. For more complex answers, speech recognition and natural language processing technology may be employed. However, in the case of simple answers of a single word or just a few words, word-spotting technology may be employed. For example, the speech recognition module of dialog system 54 includes a word spotting engine, e.g., as part of the answer checking component 86, which compares the spoken word(s) with a single stored synthesized answer word. In this embodiment, the dialog system 54 only has to detect the presence/absence of the stored word in the speech utterance (see, e.g., Rose, R. & Paul, D., A hidden Markov model based keyword recognition system, in ICASSP, pp. 129-132 (1990)). This enables the dialog system 54 to be more robust to hesitations. To improve the accuracy of the system, the word-spotting engine may be adapted to the voice of a particular user (see, e.g., P. Woodland, Speaker Adaptation: Techniques and Challenges, ASRU workshop, pp. 85-88 (1999)).

If the answer is considered correct by the dialog system 54, then it can stop or ask a new question. If the system 54 is unsure as to whether the answer is correct or not, e.g., the speech recognition module 86 has a low confidence in the answer, it may ask the child to repeat the answer. If the answer is considered incorrect or if no answer is provided by the child in an allotted time, the system 54 may either provide the answer (by displaying/uttering the answer) and/or it may provide help to the child.

### 4) Reading for Comprehension Skill Development

In the process of assessing comprehension it is also beneficial to teach the child skills of reading for understanding. The manner and order of questions posed to the reader and even the subsequent probes based on the reader's responses can be purposefully didactic. To teach ‘previewing’ (before the book is read) the system 12 may ask the child to quickly flip through the book without reading it and answer some general questions to encourage the reader to think about what the story is about (for example, “the system may ask “is the story is about a window/girl?”). Previewing is a way of setting some ‘groundwork’, a base upon which the child builds as he/she reads. Thus, even in assessing comprehension, the skills of reading for comprehension can be developed.

### 5) Helping the Child (S122)

In one embodiment, the dialog system 54 may lack provision for helping the reader, only asking questions and assessing their correctness, i.e., serving purely for evaluation. In general, however, in the case of an incorrect answer (or of no answer) it is beneficial to help the child to find the correct answer themselves. Two ways to help children are (a) providing them with textual/visual cues and (b) reformulating the question/asking a related question:

One way to provide a clue to a child is to display the page of the book 14 which contains the answer. The entire page of interest may be displayed or just a portion of the page (e.g., only the paragraph or the sentence containing the answer). Alternatively, the whole text may be shown with the paragraph or the sentence which contains the answer highlighted. If the page contains mixed textual and visual content, only the textual part (a textual clue), only the visual part (a visual clue), or both parts may be displayed. Or, an oral or text prompt such as “read page two of the book again and see if you can answer the question” may be provided. Or a visual clue may be given, such as “have a look at the picture on page 2.” Especially in books for younger students, the presence of supporting visual elements, e.g., pictures, illustrations, or drawings, can be assumed. Or, the digital document may include metadata or otherwise associated information describing the content of the visual elements which can be extracted and used in formulating help prompts. Thus, some of the questions can relate to these supporting visual elements, e.g., “in the picture on this page what is Dad doing?”

One way to provide a strong hint to the child without providing the answer is to give a definition of the answer. For example, the initial question may be “Where did Mina look for her jacket first?” If the expected answer is “in the kitchen,” then the system may look for the definition of the word “kitchen” in a children's dictionary accessible online or stored in a database (see, e.g., http://kids.yahoo.com/reference/dictionary/english). In the case of “kitchen,” the definition “a room or an area equipped for preparing and cooking food” could be formulated into an interrogative sentence: “What is the room or area equipped for preparing and cooking food?”

If multiple questions have the same answer, another option is to ask the child another question pertaining to the same subject. In another embodiment, the question may be modified. For example, the same question may be stored in two formats “where did Mina look?” and “Did Mina look in the closet?”

### 6) Recording (S120)

Statistics may be recorded to follow the progress of a child, such as the number of questions answered correctly without any hint, the number of questions answered correctly after one hint, or two or three hints, the number of questions the child was unable to answer even after multiple hints, etc.

### 7) Parsing of the Input Text (S104)

In some embodiments, the parser 50 comprises an incremental parser, as described, for example, in above-referenced U.S. Pat. No. 7,058,567, by Aït-Mokhtar, et al., in U.S. Pub. Nos. 2005/0138556 and 2003/0074187, the disclosures of which are incorporated herein in their entireties by reference, and in the following references: Aït-Mokhtar, et al., Incremental Finite-State Parsing, Proc. Applied Natural Language Processing, Washington, April 1997; Aït-Mokhtar, et al., Subject and Object Dependency Extraction Using Finite-State Transducers, Proc. ACL'97 Workshop on Information Extraction and the Building of Lexical Semantic Resources for NLP Applications, Madrid, July 1997; Aït-Mokhtar, et al., Robustness Beyond Shallowness Incremental Dependency Parsing, NLE Journal, 2002; Aït-Mokhtar, et al., A Multi-Input Dependency Parser, in Proc. Beijing IWPT 2001; Caroline Hagège and Claude Roux, Entre syntaxe et sémantique: Normalisation de l'analyse syntaxique en vue de l'amélioration de l'extraction d'information, Proceedings TALN 2003, Batz-sur-Mer, France (2003) (“Hagège and Roux”), and Caroline Brun and Caroline Hagège, Normalization and paraphrasing using symbolic methods, ACL: Second Intl workshop on Paraphrasing, Paraphrase Acquisition and Applications, Sapporo, Japan, Jul. 7-12, 2003 (“Brun and Hagège”).

One such parser 50 is the Xerox Incremental Parser (XIP), which, for the present application, may have been enriched with additional processing rules for generating questions. Other natural language processing or parsing algorithms can alternatively be used.

The exemplary parser 50 may include includes various software modules executed by processor 40. Each module works on the input text, and in some cases, uses the annotations generated by one of the other modules, and the results of all the modules are used to annotate the text. The exemplary parser 50 allows deep syntactic parsing. For enabling question generation, the parser may be used to perform robust and deep syntactic analysis, enabling extraction of the information needed to perform question generation from texts. Deep syntactic analysis may include construction of a set of syntactic relations from an input text, inspired from dependency grammars (see Mel'\check{c}uk, I., Thesis: Dependency Syntax, State University of New York, Albany (1998), and Tesnière, L. (1969) Eléments de syntaxe structurale, Editions Klincksieck, Deuxième edition revue et corrigée, Paris (1959)). These relations (which may be binary and more generally n-ary relations) link lexical units of the input text and/or more complex syntactic domains, such as words or groups of words, that are constructed during the processing (mainly chunks, see Abney, S. Parsing by Chunks, in Robert Berwick, Steven Abney and Carol Tenny (eds.), Principle-Based Parsing, Kluwer Academic Publishers (1991)). These relations are labeled, when possible, with deep syntactic functions. More precisely, a predicate (verbal or nominal) is linked with its arguments: its deep subject (SUBJ-N), its deep object (OBJ-N), and modifiers. Moreover, together with surface syntactic relations handled by a general English grammar, the parser calculates more sophisticated and complex relations using derivational morphology properties, deep syntactic properties (subject and object of infinitives in the context of control verbs), and the like (see Hagège and Roux, and Brun and Hagège for details on deep linguistic processing using XIP).

In particular, the natural language processing results in the extraction of normalized syntactic dependencies, such as subject-verb dependencies, object-verb dependencies, modifiers dependencies (e.g., locative or temporal modifiers), and the like.

The exemplary parser also includes a Named Entity recognition module. Named Entities are specific lexical units that refer to an entity of the world in special areas and to which can be associated a semantic tag. While the named entity detection system may primarily focus on detection of proper names, particularly person names, for this application, other predefined classes of named entities may be recognized, such as percentages, dates and temporal expressions, amounts of money, organizations, events, and the like. The objective of a named entity recognition system is to identify named entities in unrestricted texts and to assign them a type taken from a set of predefined categories of interest, e.g., through access to an online resource, such as Wordnet™. Methods for identifying named entities are described, for example, in U.S. Pat. Nos. 6,975,766 and 7,171,350, and U.S. Pub. No. 2009/0204596, the disclosures of which are incorporated herein in their entireties by reference.

The parser 50 may further include a pronominal coreference resolution module. Coreference resolution aims at detecting antecedent entities of nouns and pronouns within the text. This is useful in the present application, since even very simple texts dedicated to children require the reader to comprehend pronoun reference (e.g., that “she said” is referring to what the previously named female person, Mina, said, or that “him” probably refers to the previously-mentioned male person, “Dad”). The coreference resolution module may be based on lexico-semantic information as well as on heuristics that detect the most appropriate antecedent candidate of entities in focus in the discourse. Methods for co-reference resolution are described in U.S. Pub. No. 2009/0076799, the disclosure of which is incorporated herein in its entirety by reference.

An example of the kind of parsing output (syntactic dependencies first, chunk tree last), which the parser 50 may provide when parsing the following text is shown below:

“It is snowing,” said Dad.
SUBJ-N_POST(said,Dad)
SUBJ-N_PRE(snowing,lt)
MAIN(said)
MAIN_PROGRESS(snowing)
EMBED_COMPLTHAT(snowing,said)
0>TOP{SC{NP{lt} FV{is}} NFV{snowing} , SC{FV{said} NP{Dad}}}
“You should get your jacket.”
VDOMAIN_MODAL(get,should)
SUBJ-N_PRE(get,You)
MAIN_MODAL(get)
OBJ-N(get,jacket)
1> TOP{SC{NP{You} FV{should}} IV{get} NP{your jacket} .}
Mina looked in the closet.
MOD_POST(looked,closet)
VDOMAIN(looked,looked)
SUBJ-N_PRE(looked,Mina)
PREPD(closet,in)
MAIN(looked)
PERSON(Mina)
2>TOP{SC{NP{Mina} FV{looked}} PP{in NP{the closet}} .}
“No jacket,” she said.
MOD_POST_APPOS(jacket,she)
SUBJ-N(said,she)
MAIN(said)
ATTRIB_APPOS(jacket,she)
COREF_REL(She, Mina)
3>TOP{NP{No jacket}, SC{NP{she} FV{said}} .}

The abbreviations in capitals are the dependencies identified, for the text elements in parenthesis as expressed in the XIP language. For example, SUBJ-N_POST(said,Dad) implies that a subject verb dependency has been identified between text elements said and Dad in which the subject is positioned after the verb. COREF_REL indicates a coreference dependency has been identified, in this case between the pronoun she and the antecedent Mina. As will be appreciated, more dependencies than these can be identified from each sentence. In the sentence chunk tree representation, each “{ . . . }” denotes a set of sub-nodes.

In question generating, the parser 50, or a separate module 52, may be used for the generation of text from dependencies. The generation process may include taking as input a semantic representation and generating the corresponding sentence in natural language. The process is usually driven by a generation grammar whose goal is to produce a syntactic tree. The semantic representation can be a set of dependencies, such as object or subject relations, which define how the different words in the final sentence relate to each other. These dependencies can be used to build a syntactic tree and compute the correct surface form for each word, according to the existing agreement rules in the target language. Other rules might add the correct determiners to output the final result:

Thus, from a set of dependencies such as below:

Subject (eat, dog)

Object (eat, bone)

The system might use the following rules:

Build a first S (sentence tree) with two sub-nodes below: NP,VP:

If (subject(verb, noun)) S{NP{noun}, VP{verb}}

Then add under the VP sub-node a NP node:

If (object(verb, noun)) VP {verb, NP{noun}}

If there is a subject relation, then the noun and the verb must agree in person:

If (subject(verb, noun)) agreement (verb, noun).

The following output will then be produced out of the first two dependencies:

S{NP{dog},VP{eat, NP{bone}}}

Where each “{ . . . }” denotes a set of sub-nodes.

The agreement relation will be used to compute the appropriate surface form for the verb and the noun. Other rules may add the correct determiners to output the final result:

The dog eats the bone.

To generate text-associated questions, a question generation grammar can be provided, in the parser language. For example, the question generation grammar may use entities related to the text (e.g., persons, places, objects), as well as their relations with main predicates of the sentences. According to the type of the entities (persons, object, places), the system generates corresponding questions (e.g., wh-questions, including the word who, what, where). The question generation also stores the correct answer to the question, during the generation process, in order to map it with the reader's answer. The generation rules, generate the appropriate corresponding questions (who for person, where for place, what for object) according to the type of entities and the type of predicates (full verb, copula), with the appropriate word order and morphological surface forms.

For example, the following text is input to the system 12:

“It is snowing” said Dad. “You should get your jacket.”

Mina looked in the closet. “No jacket,” she said.

Mina looked in her bedroom. “No jacket,” she said.

Mina looked in the kitchen. “Here it is!” she said.

The question generator 52 gives as output the following set of questions (answers):

| | |
|---|---|
| What does Dad say? | (It is snowing) |
| Who looks in the closet? | (Mina) |
| Where does Mina look? | (in the closet) |
| What does Mina say? | (No jacket) |
| Who looks in her bedroom? | (Mina) |
| Where does Mina look? | (in her bedroom) |
| Who looks in the kitchen? | (Mina) |
| Where does Mina look? | (in the kitchen) |
| Where is the jacket? | (in the kitchen) |

The full process on the sentence Mina looks in the closet is described by way of example. The first step (step 1) is to analyze the sentence with the parser's English grammar. The dependencies given as output are the following:

MOD_LOC(looks,closet)

SUBJ-N_PRE(looks,Mina)

PREP(closet,in)

MAIN(looks)

HEAD(closet,the closet)

DET(closet,the)

HEAD(Mina, Mina)

HEAD(closet,in the closet)

PERSON(Mina)

VTENSE_PRES(looks)

The dependency MOD_LOC means that a locative complement of the main verb has been identified: it triggers the generation of a where_question; The analysis grammar also identifies that an entity of type person (PERSON(Mina)) is the subject of the main verb: therefore a who_question will be also generated from this sentence. The corresponding generation rules are the following:

```
      //## Generation of where_question
      if(MOD_LOC(verb,noun1) & SUBJ-N(verb,noun2})
      S{NP{PRON{Where}},VP{AUX(do),NP{noun2},verb},?}
      //## Generation of who_question
      if (SUBJ(verb,noun1) & PERSON(noun1) &
MOD_LOC(verb,noun2) & PREP(noun2,prep) & DET(noun2,det))
      S{NP{PRON{Who},VP{verb,PP{prep,NP{det,noun2}}},?}
```

For the where_question, the first rule matches the dependencies extracted by step 1, so it applies, the output tree is then:

S{NP{PRON{Where},VP{AUX{do},NP{Mina},look},?}

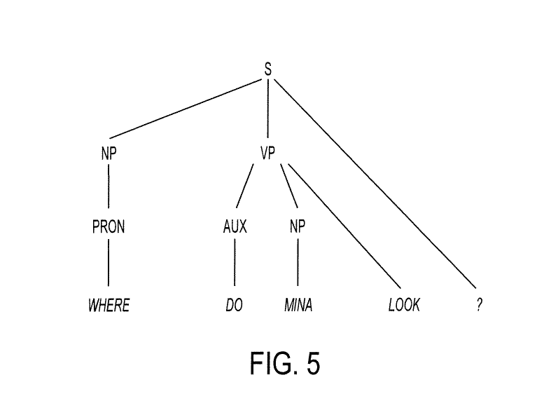

This is graphically equivalent to the dependency tree shown in FIG. 5. It corresponds to the output sentence: “Where does Mina look?”, once the agreement rules have been applied.

For the who-question, the second rule matches the dependencies extracted by step 1, it applies also, the output tree is then:

S{NP{PRON{Who},VP{look,PP{in,NP{the,closet}}},?}

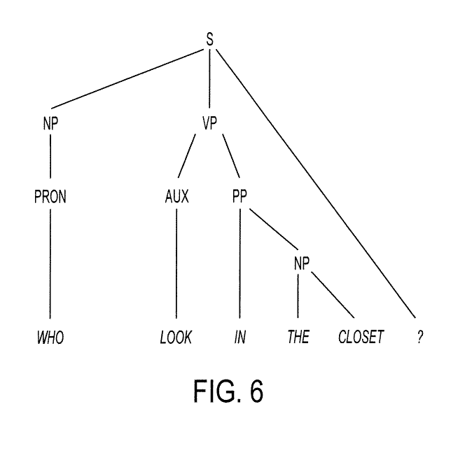

This is graphically equivalent to the dependency tree shown in FIG. 6. It corresponds to the output sentence: “Who looks in the closet?”, once the agreement rules have been applied.

The generation grammar applied by the question generation component 56 may generate other question types in addition to generation of wh-questions, as illustrated in these examples. For example, in a first step, synonymy and paraphrasing patterns may be used to reformulate the questions to make the questions more complex, or conversely, to help the student in the case of an incorrect answer.

The input text, in the case of books for children, often contains dialogues between protagonists. As a consequence, the question generator should be able to generate questions over dialogues. Discourse analysis components, such as the coreference resolution module, facilitates generation of such questions by identifying the speaker, e.g., the antecedent for he in he said.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for evaluation of a reader's comprehension, comprising:
receiving an input text;
natural language processing the text to identify dependencies between text elements in the input text;
with a computer processor, applying grammar rules to generate questions and associated answers from the processed text, at least some of the questions each being based on at least one of the identified dependencies;
automatically posing questions from the generated questions to a reader of the input text;
evaluating comprehension of the reader based on received responses of the reader to the questions posed.

2. The method of claim 1, wherein the receiving an input text includes receiving a digital version of a hardcopy document to be read by the reader.

3. The method of claim 1, wherein the natural language processing includes inputting the text to a parser, the parser comprising instructions stored in memory for identifying different types of dependencies, which are executed by an associated computer processor.

4. The method of claim 1, wherein the natural language processing includes identifying coreference links between pronouns and their antecedent text elements and the question generating includes generating a question based on an identified antecedent text element and a text element in the input text, the text element identified as being in a dependency with a pronoun linked by coreference to the antecedent text element.

5. The method of claim 1, wherein the natural language processing includes identifying named entities and wherein the question generating includes generating a question based on an identified named entity and a text element in the input text, the text element identified as being in a dependency with the identified named entity.

6. The method of claim 1, wherein the applying grammar rules to generate questions and associated answers from the processed text comprises at least one of:
applying a grammar rule for generating a who-type question where a person name is identified in the input text as being in a dependency with an identified verb in the input text, wherein the identified verb and the person name are used in generating the who-type question; and
applying a grammar rule for generating a where-type question where a location is identified in the input text as being in a dependency with an identified verb in the input text, wherein the identified verb and the location are used in generating the where-type question.

7. The method of claim 1, wherein the posing of questions includes outputting a generated question as synthesized speech.

8. The method of claim 7, wherein the received responses of the reader comprise spoken responses and wherein the evaluation comprises comparing the spoken answer with a synthesized speech version of the generated associated answer.

9. The method of claim 1, further comprising identifying a reading level of the reader and wherein the posed questions or associated answers include words selected from a set of words designated as being appropriate to the reading level.

10. The method of claim 1, wherein when a comparison of the reader's answer with the generated answer indicates the reader's answer is incorrect, automatically providing the reader with help, the evaluation of comprehension taking into account the help provided to the reader.

11. The method of claim 1, wherein the dependencies include normalized syntactic dependencies selected from the group consisting of:
subject-verb dependencies;
object-verb dependencies;
modifiers dependencies;
and combinations thereof.

12. The method of claim 1, wherein the applying of the grammar rules to generate questions and associated answers from the processed text comprises generating question in the form of a dependency tree from words in the input text which satisfy one of the grammar rules and applying agreement rules to the dependency tree.

13. The method of claim 1, wherein at least some of the questions are each based on a plurality of the identified dependencies.

14. The method of claim 1, further comprising generating questions which are each based on an image associated with the input text.

15. The method of claim 1, further comprising outputting a report based on the evaluation.

16. The method of claim 1, wherein the text comprises a children's book.

17. The method of claim 1, further comprising displaying at least one of the input text and the posed questions on a display.

18. A computer program product encoding instructions, which when executed by a computer, perform the method of claim 1.

19. An apparatus for performing the method of claim 1 comprising:
memory which receives the input text;
memory which stores instructions for:
natural language processing the text to identify dependencies between text elements in the input text,
applying grammar rules to generate questions and associated answers from the processed text, at least some of the questions being based on the identified dependencies,
posing questions from the generated questions to a reader of the input text, and
outputting an evaluation of comprehension of the reader based on received responses of the reader to the questions posed; and
a processor in communication with the memory which executes the instructions.

20. The apparatus of claim 19, wherein the apparatus comprises an e-reader which displays the text and poses the questions.

21. A system for evaluation of a reader's comprehension comprising:
memory which stores instructions for:
receiving natural language processed input text,
applying grammar rules to generate questions and associated answers from the processed text, at least some of the questions being based on syntactic dependencies identified in the processed text,
posing questions from the generated questions to a reader of the input text, and
evaluating comprehension of the reader based on received responses of the reader to the questions posed; and
a processor in communication with the memory which executes the instructions.

22. The system of claim 21, further comprising a text to speech converter for converting generated questions into synthesized speech.

23. The system of claim 21, further comprising a display for displaying at least one of the input text and the posed questions.

24. The system of claim 21, wherein the memory stores instructions for outputting a report based on the evaluation.
